(19) United States
(12) Patent Application Publication
(10) Pub. No.: US 2026/0147723 A1
(43) Pub. Date: May 28, 2026

(54) OPTIMIZING FREQUENCY OF I/O ADAPTER INITIATION COMMANDS

(71) Applicant: International Business Machines Corporation, Armonk, NY (US)

(72) Inventors: Charles Cruse, Raleigh, NC (US); Randall Todd Kunkel, Apex, NC (US); Jerry Stevens, Raleigh, NC (US)

(73) Assignee: International Business Machines Corporation, Armonk, NY (US)

(21) Appl. No.: 18/960,912

(22) Filed: Nov. 26, 2024

(51) Int. Cl. G06F 13/20

(52) U.S. Cl. CPC G06F 13/20; G06F 2213/40

(57) ABSTRACT

A computer-implemented technique of optimizing input/output (I/O) packet batch sizes includes processing circuitry, based on receiving a first I/O request, issuing a data available notification to an I/O adapter to initiate communication of a data payload of the I/O request between the I/O adapter and at least one data queue. The processing circuitry determines whether an adapter initiation command was utilized to transition an adapter state of the I/O adapter from a quiescent state to a busy state to process the data payload of the I/O request. Based on a determination that an adapter initiation command was utilized, the processing circuitry increases a current packet batch size applicable to a subsequent second I/O request. In some examples, once the packet batch size reaches a maximum value, the batch size is reset to an initial packet batch size when the I/O adapter remains in the idle state.

### BACKGROUND OF THE INVENTION

The present invention relates in general to data processing, and more specifically, to input/output (I/O) in a data processing system. Still more particularly, the present invention relates to optimization of the frequency of communicating I/O adapter initiation commands.

I/O adapters are essential components in modern computing systems, facilitating communication between the central processing unit (CPU) and external devices. These adapters adhere to specific I/O communication standards to ensure peripheral compatibility and efficient data transfer. PCIe has emerged as a dominant I/O communication standard due to its support for high-speed, serial communication and a wide variety of device types, including graphics cards, network adapters, and storage controllers.

Despite continuing advancements in I/O standards, continuing improvement in I/O subsystems remains a complex challenge. Some key areas in the development and management of I/O subsystems include driver development, optimized allocation of system resources (e.g., memory and interrupt lines), robust error handling, and data security. Additionally, another area of development is packet batch size optimization: The choice of packet batch size can significantly impact I/O performance. Larger packet batch sizes can reduce communication overhead but may introduce latency, while smaller packet batch sizes can increase communication overhead but may improve responsiveness.

### SUMMARY OF THE INVENTION

In view of the foregoing, the present application discloses an innovative technique for optimizing the frequency of I/O adapter initiation commands.

In accordance with one or more embodiments, a computer-implemented technique of optimizing input/output (I/O) packet batch sizes can be implemented as a method, system, and/or computer program product. In one embodiment, processing circuitry, based on receiving a first I/O request, issues a data available notification to an I/O adapter to initiate communication of a data payload of the I/O request between the I/O adapter and at least one data queue. The processing circuitry determines whether or not an adapter initiation command was utilized to transition an adapter state of the I/O adapter from a quiescent state to a busy state to process the data payload of the I/O request. Based on a determination that an adapter initiation command was utilized, the processing circuitry increases a current packet batch size applicable to a subsequent second I/O request. In one or more embodiments, the I/O request can be an I/O read request or an I/O write request.

In accordance with one or more embodiments, the computer-implemented technique includes based on receiving a first I/O write request, issuing, by processing circuitry of a computer, a data available notification to an I/O adapter to initiate communication of a data payload of the first I/O write request from at least one data queue to an I/O adapter. The processing circuitry determines whether an adapter initiation command was utilized to transition an adapter state of the I/O adapter from a quiescent state to a busy state to process the data payload of the first I/O write request. Based on a determination that an adapter initiation command was utilized, the processing circuitry increases a current packet batch size applicable to a subsequent second I/O write request. The processing circuitry thereafter iteratively optimizes the current packet batch size on utilization of adapter initiation commands.

### BRIEF DESCRIPTION OF THE DRAWINGS

FIG. 1 is a high-level block diagram of an exemplary data processing environment in accordance with one or more embodiments;

FIG. 2 is a more detailed block diagram of a portion of data processing environment of FIG. 1 relevant for implementing input/output (I/O) operations in accordance with one or more embodiments; and

FIG. 3 is a high-level logical flowchart of an exemplary process of optimizing the frequency and/or number of adapter initiation commands for I/O communication in accordance with one or more embodiments.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

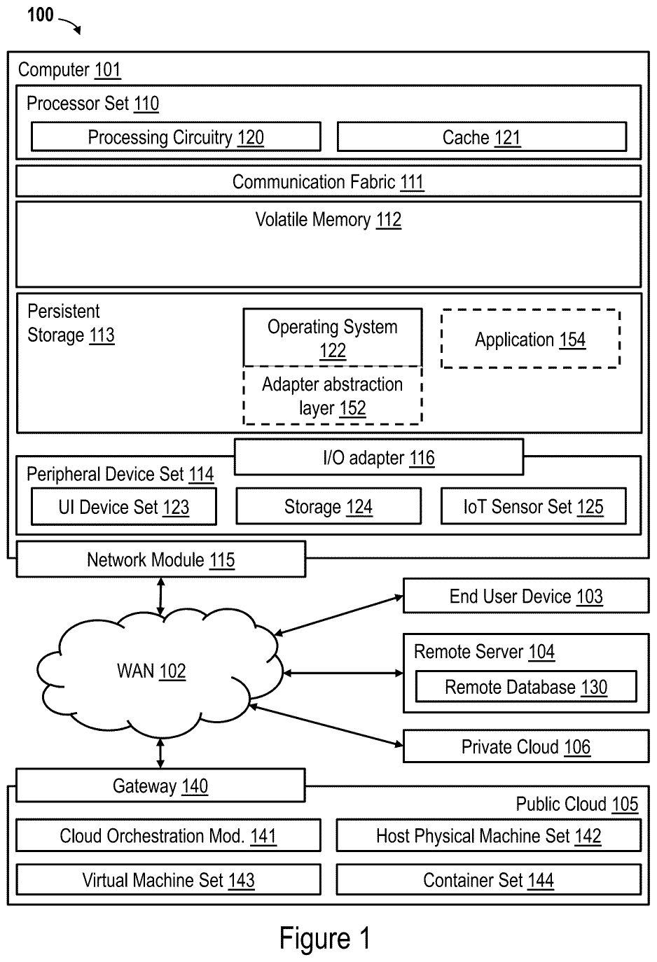

With reference now to FIG. 1, computing environment 100 contains an example of an environment for the execution of at least some of the computer code, such as operating system 122, involved in performing the inventive methods. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and other code and data), peripheral device set 114 (including user interface (UI) device set 123, storage 124, and Internet of Things (IoT) sensor set 125), and network module 115. At least some of peripheral device set 114 may be accessed by other components of computer 101 via an I/O adapter 116, such as a PCIe adapter. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be implemented in operating system 122 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 122 typically includes at least some of the computer code involved in performing the inventive methods. Persistent storage 113 may additionally store other code executed by processing circuitry 120, including an optional application 154 and an optional adapter abstraction layer 152. In some embodiments, adapter abstraction layer 152 can be implemented in low-level firmware for abstracting and managing implementation-specific communication with I/O adapter 116 for operating system 122.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet-of-Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the Internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Those of ordinary skill in the art will appreciate that the architecture and components of a data processing environment can vary between embodiments. Accordingly, the exemplary computing environment 100 given in FIG. 1 is not meant to imply architectural limitations with respect to the claimed invention.

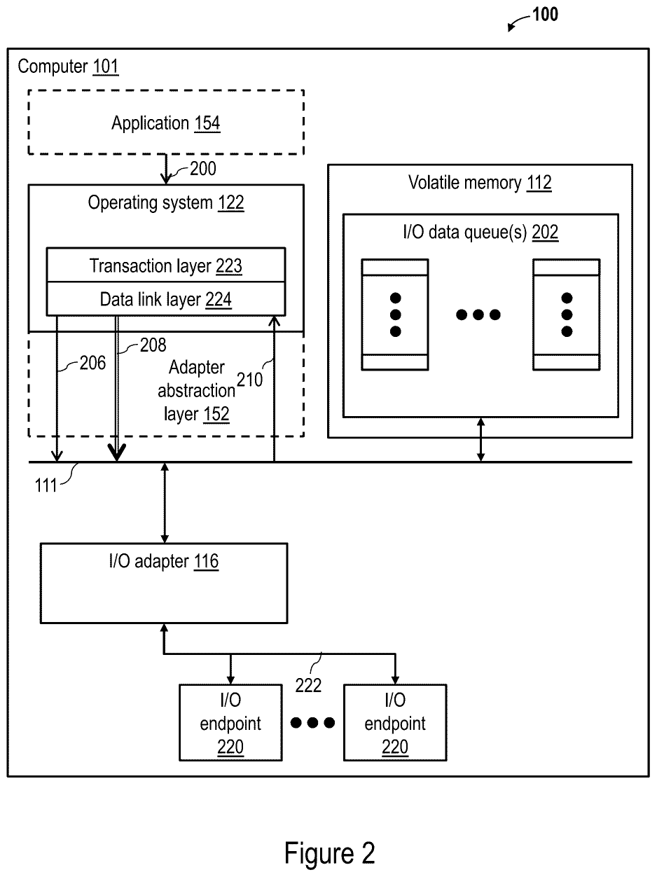

Referring now to FIG. 2, there is depicted a more detailed block diagram of a portion of data processing environment 100 of FIG. 1 relevant for implementing input/output (I/O) operations in accordance with one or more embodiments. The illustrated portion of data processing environment 100 includes a computer 101 having an application 154, operating system 122, volatile memory 112, communication fabric 111, and I/O adapter 116 as previously described with reference to FIG. 1. I/O adapter 116 supports the attachment of one or more I/O endpoints 220 via an I/O communication channel 222, which in one embodiment can be a PCIe bus. I/O endpoints 220 can be, for example, devices within peripheral device set 114 or alternative or additional I/O devices.

In the depicted view, application 154, which is optional, can be executed by processing circuitry 120 to generate various I/O requests 200, which are received by operating system 122. I/O requests 200 can additionally be generated for network devices, for example, by operating system 122 when data originates from an input network device of a computer 101.

These I/O requests 200 can include I/O read requests that request communication of I/O data, via I/O adapter 116, from an I/O endpoint 220 to a data destination (e.g., application 154 or operating system 122) and I/O write requests that request communication of I/O data, via I/O adapter 116, from a data source (e.g., an input device, application 154, or operating system 122) to an I/O endpoint 220. In order to buffer, manage, track, and prioritize various I/O traffic flows, operating system 122 can allocate and maintain in data storage, such as volatile memory 112, one or more I/O data queues 202. Operating system may direct I/O traffic to various ones of I/O data queues 202 based, for example, on the I/O endpoint 220, traffic priority, traffic type (e.g., payload), request type (e.g., I/O read or I/O write), load balancing, and/or other criteria.

Operating system 122, which can include a hypervisor, VM OS, or native OS, implements the transaction layer 223 and data link layer 224 of one or more I/O communication protocols, such as PCIe. Transaction layer 223 provides I/O device configuration and control and manages data transfer to and from I/O data queues 202 in volatile memory 112. Transaction layer 223 additionally provides message and error reporting. Data link layer 224 manages assembly and transfer of data packets between operating system 122 and I/O endpoints 220 and implements the flow control mechanism and the packet acknowledgement for the I/O protocol. Data link layer 224 also manages entry by I/O adapter 116 into lower power states in order to reduce power dissipation. Those skilled in the art will appreciate that in some embodiments data link layer 224 can be implemented by a device driver, as is known in the art.

As noted briefly above, in some embodiments, operating system 122 can be augmented by optional additional firmware executed on processing circuitry 120, which is referred to herein as adapter abstraction layer 152. In embodiments including adapter abstraction layer 152, adapter abstraction layer 152 can support data link layer 224 of operating system 122 by abstracting details of the status and operation of I/O adapter 116, for example, including by determining the status of I/O adapter 116 on behalf of operating system 122 and/or data link layer 224. The status of I/O adapter 116 can be provided to operating system 122 and/or data link layer 224 in a status indication 210.

In accordance with one aspect of the disclosed inventions, operating system 122 preferably optimizes I/O packet batch (bundle) sizes based on feedback obtained from I/O adapter 116. As will be appreciated by those skilled in the art, the data link layer 224 implemented by operating system 122 initiates the I/O packet flow by transmitting an adapter initiation command 206, commonly referred to in the art as a “tap.” The processing of operating system 122 to generate the adapter initiation command is a synchronous operation with a significant CPU cost, and it is preferable to reduce or minimize generation of adapter initiation commands that are not required. If the I/O packet batch size is too low for the traffic volume for an I/O stream of a given throughput, CPU resources are wasted through the generation of frequent or additional (non-optimal) adapter initiation commands; however, if the I/O packet batch size is too large for an I/O stream of a given throughput, the I/O stream incurs added latency as each large packet batch is assembled. Operating system 122 therefore optimizes I/O packet batch sizes to reduce or eliminate the generation and transmission of unneeded or excess adapter initiation commands.

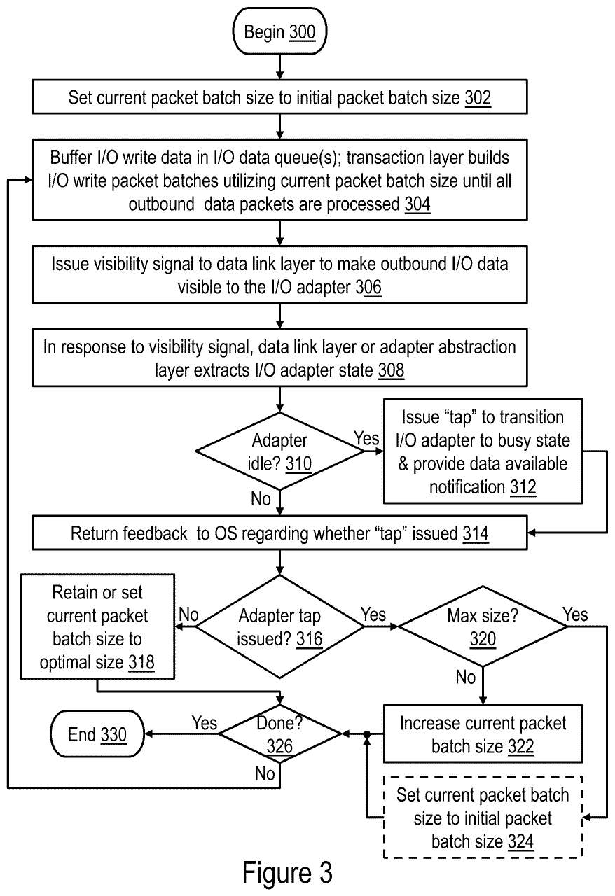

With reference now to FIG. 3, there is illustrated a high-level logical flowchart of an exemplary process of optimizing the frequency and/or number of adapter initiation commands for I/O communication in accordance with one or more embodiments. The process of FIG. 3 begins at block 300, for example, in response to receipt by operating system 122 of an I/O write request and associated data that is generated, for example, by an input device of computer 101, operating system 122, or application 154 (block 302). In response to receipt of the I/O write request at block 300, operating system 122 initializes a current packet batch size for I/O data communicated between I/O data queue(s) 202 and I/O endpoint(s) 220 via I/O adapter 116 (block 302). For example, in some embodiments or operating modes, operating system 122 can initialize the current packet batch size to a predetermined initial packet batch size, such as 16 or 32 I/O packets, which can be determined based, for example, on adapter type and/or communication capabilities of I/O adapter 116. In other embodiments or operating modes, operating system 122 can dynamically determine the initial packet batch size based, for example, on the adapter type of I/O adapter 116 and/or performance-based heuristics.

In addition, at block 304, operating system 122 causes the data payload of the I/O write request to be buffered in I/O data queue(s) 202. Transaction layer 223 additionally builds I/O write packet batches from the data payload of the I/O write request utilizing the current packet batch size, which can be the initial current packet batch size configured at block 304 or an updated current packet batch size (as discussed below) until all outbound data packets are processed (block 304). Transaction layer 223 issues a visibility signal to data link layer 224 to make the outbound I/O data visible to I/O adapter 116 (block 306).

In response to the visibility signal, data link layer 224 extracts the adapter state of I/O adapter 116 (block 308). In one embodiment, data link layer 224 obtains this adapter state information from I/O adapter 116 through execution of an instruction by adapter abstraction layer 152 that obtains, as a result of execution, a status indication for I/O adapter 116 indicating whether I/O adapter 116 is quiescent (i.e., idle) or whether I/O adapter 116 was still processing a prior packet batch when the data visibility signal was issued (i.e., busy). A quiescent (non-busy) status implies that the current packet batch size is too small. In other embodiments, for example, those omitting adapter abstraction layer 152, data link layer 224 can obtain the feedback regarding the adapter state of I/O adapter 116 by other possibly conventional interrupt and/or message-passing communication techniques, such as mailbox communication, communication via a “doorbell” register, or the like.

At block 310, data link layer 224 determines based on whether the adapter state extracted at block 308 is an idle state. In response to an affirmative determination at block 310, data link layer 224 issues an adapter initiation command 206 (or “tap”) to transition the adapter state of I/O adapter 116 from a quiescent state to a busy state (block 312). In addition, at block 312, data link layer 224 provides a data available notification 208 to I/O adapter 116 indicating the availability of a packet batch for ingestion and transmission by I/O adapter 116. Following block 312 or a negative determination at block 310, data link layer 224 returns to operating system 122 an indication whether or not an adapter initiation command 206 was used to transition I/O adapter 116 from a quiescent state to a busy state at block 312 (block 314).

Operating system 122 (and/or data link layer 224) then optimizes the packet batch size based on the feedback indicating whether or not an adapter initiation command 206 was used to transition the adapter state of I/O adapter 116, as shown at blocks 316 to 326. For example, in response to operating system 122 determining based on the feedback received at block 314 that no adapter initiation command 206 was employed, operating system 122 retains the current packet batch size in at least one embodiment (block 318). In other embodiments, operating system 122 may set the current packet batch size to a predetermined or dynamically determined optimal packet batch size. Based on affirmative determination at block 316, operating system 122 can increase the current packet batch size if the current packet batch size is less than an operating system-determined maximum packet batch size (e.g., by increasing the packet batch size from 32 packets to 64 packets) (blocks 320-322). For example, in some embodiments, operating system 122 can increase the current packet batch size at block 322 by an integer power of 2. In some embodiments, operating system 122 can increase the current packet batch size an amount based on a then-current CPU cost for processing an adapter initiation command. If operating system 122 determines at block 320 that the current packet batch size is set at a maximum packet batch size, operating system 122 can optionally reset the current packet batch size to the initial packet batch size (block 324). In some embodiments, the reset depicted at block 324 can be performed when I/O adapter 116 has returned to an idle state.

As shown at block 326, if additional I/O write data remains to be transmitted by I/O adapter 116 to an I/O endpoint 220 following any of blocks 318, 322, and 324, the process iterative returns to block 304, which has been described. If no additional I/O write data remains to be transmitted by I/O adapter 116 to an I/O endpoint 220, the process of FIG. 3 ends at block 330.

In accordance with one or more embodiments, a computer-implemented technique of optimizing input/output (I/O) packet batch sizes can be implemented as a method, system, and computer program product. In one embodiment, processing circuitry, based on receiving a first I/O request, issues a data available notification to an I/O adapter to initiate communication of a data payload of the I/O request between the I/O adapter and at least one data queue. The processing circuitry determines whether or not an adapter initiation command was utilized to transition an adapter state of the I/O adapter from a quiescent state to a busy state to process the data payload of the I/O request. Based on a determination that an adapter initiation command was utilized, the processing circuitry increases a current packet batch size applicable to a subsequent second I/O request. In one or more embodiments, the I/O request can be an I/O read request or an I/O write request.

In one or more embodiments, feedback regarding whether an adapter initiation command was utilized to transition the adapter state can reflect the state of a single transmit queue or multiple transmit queues, such that the current packet batch size is optimized.

In one or more embodiments, based on a determination that an adapter initiation command was not utilized, the processing circuitry retains the current packet batch size or decreases the current packet batch size, such that the current packet batch size is optimized.

In one or more embodiments, increasing the current packet batch size includes increasing the current packet batch size an amount based on a then-current CPU cost for processing an adapter initiation command, such that the current packet batch size is optimized.

In one or more embodiments, determining whether or not an adapter initiation command was utilized to transition the adapter state includes executing an adapter abstraction layer firmware instruction to determine an adapter state of the I/O adapter. Making the determination via the adapter abstraction layer enables abstraction of the details of the I/O adapter from higher layers of software.

In one or more embodiments, the at least one data queue includes a plurality of data queues for buffering data payloads of I/O requests and determining whether or not an adapter initiation command was utilized to transition the adapter state includes determining the adapter state of the I/O adapter based on whether the I/O adapter is communicating I/O data with any of the plurality of data queues. In this manner, the determination of adapter state can be made across streams of I/O traffic.

In at least some embodiments, the optimization of the current packet batch size iterates until either an optimal (or maximum) packet batch size is reached, allowing one or more data communication to employ the optimal or maximum packet batch size, or the I/O adapter transitions to an idle adapter state. In some embodiments, once the packet batch size reaches a maximum value, the batch size is reset to an initial packet batch size when the I/O adapter remains in the idle state.

While the present invention has been particularly shown as described with reference to one or more preferred embodiments, it will be understood by those skilled in the art that various changes in form and detail may be made therein without departing from the spirit and scope of the invention.

The following definitions are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, system or apparatus that comprises a list of elements is not necessarily limited to only those elements but can include other elements not expressly listed or inherent to such composition, mixture, process, method, article, system or apparatus.

Additionally, the term “exemplary” is used herein to mean “serving as one example, instance or illustration.” Any embodiment or design described herein as “exemplary” is not necessarily to be construed as preferred or advantageous over other embodiments or designs. The terms “at least one” and “one or more” shall be understood to include any integer number greater than or equal to one, and the term “plurality” shall be understood to include any integer number greater than or equal to two. The term “coupled” shall include both indirect connection and a direct connection, unless specified otherwise in a particular case. The terms “about,” “substantially,” “approximately,” and variations thereof, are intended to include the degree of error associated with measurement of the particular quantity based upon the equipment available at the time of filing the application. For example, “about” can include a range of ±10% or ±5%, or ±2% of a given value.

The figures described herein and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. For the sake of brevity, conventional techniques related to making and using aspects of the invention(s) may or may not be described in detail herein, and many conventional implementation details are only mentioned briefly or are omitted entirely. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a” is not intended as limiting of the number of items.

What is claimed is:

1. A computer-implemented method of optimizing input/output (I/O) packet batch sizes, the method comprising:
based on receiving a first I/O request, issuing, by processing circuitry, a data available notification to an I/O adapter to initiate communication of a data payload of the first I/O request between an I/O adapter and at least one data queue;
the processing circuitry determining whether an adapter initiation command was utilized to transition an adapter state of the I/O adapter from a quiescent state to a busy state to process the data payload of the first I/O request; and
based on a determination that an adapter initiation command was utilized, the processing circuitry increasing a current packet batch size applicable to a subsequent second I/O request.

2. The method of claim 1, and further comprising:
based on a determination that an adapter initiation command was not utilized, the processing circuitry retaining the current packet batch size.

3. The method of claim 1, and further comprising:
based on a determination that an adapter initiation command was not utilized, the processing circuitry decreasing the current packet batch size.

4. The method of claim 1, wherein increasing the current packet batch size includes increasing the current packet batch size an amount based on a then-current CPU cost for processing an adapter initiation command.

5. The method of claim 1, wherein the determining includes executing an adapter abstraction layer firmware instruction to determine an adapter state of the I/O adapter.

6. The method of claim 1, wherein:
the at least one data queue includes a plurality of data queues for buffering data payloads of I/O requests; and
the determining includes determining the adapter state of the I/O adapter is busy based on the I/O adapter communicating I/O data with any of the plurality of data queues.

7. The method of claim 1, further comprising:
resetting the current packet batch size to an initial value based on the I/O adapter resuming an idle state.

8. The method of claim 1, further comprising the processing circuitry iteratively optimizing the current packet batch size based on utilization of adapter initiation commands.

9. A computer program product, comprising:
a storage device; and
program code stored within the storage device and executable by processing circuitry of a data processing system to perform operations including:
based on receiving a first I/O request, issuing a data available notification to an I/O adapter to initiate communication of a data payload of the first I/O request between an I/O adapter and at least one data queue;
determining whether an adapter initiation command was utilized to transition an adapter state of the I/O adapter from a quiescent state to a busy state to process the data payload of the first I/O request; and
based on a determination that an adapter initiation command was utilized, increasing a current packet batch size applicable to a subsequent second I/O write request.

10. The computer program product of claim 9, wherein the program code, when executed, further causes the data processing system to perform:
based on a determination that an adapter initiation command was not utilized, retaining the current packet batch size.

11. The computer program product of claim 9, wherein the program code, when executed, further causes the data processing system to perform:
based on a determination that an adapter initiation command was not utilized, decreasing the current packet batch size.

12. The computer program product of claim 9, wherein increasing the current packet batch size includes increasing the current packet batch size an amount based on a then-current CPU cost for processing an adapter initiation command.

13. The computer program product of claim 9, wherein the determining includes executing an adapter abstraction layer firmware instruction to determine an adapter state of the I/O adapter.

14. The computer program product of claim 9, wherein:
the at least one data queue includes a plurality of data queues for buffering data payloads of I/O write requests; and
the determining includes determining the adapter state of the I/O adapter is busy based on the I/O adapter communicating I/O data with any of the plurality of data queues.

15. The computer program product of claim 9, wherein the operations further include:
resetting the current packet batch size to an initial value based on the I/O adapter resuming an idle state.

16. The computer program product of claim 9, wherein the operations further include iteratively optimizing the current packet batch size based on utilization of adapter initiation commands.

17. A data processing system, comprising:
processing circuitry; and
a storage device coupled to the processing circuitry, wherein the storage device includes program code executable by the processing circuitry to perform operations:
based on receiving a first I/O request, issuing a data available notification to an I/O adapter to initiate communication of a data payload of the first I/O request between an I/O adapter and at least one data queue;
determining whether an adapter initiation command was utilized to transition an adapter state of the I/O adapter from a quiescent state to a busy state to process the data payload of the first I/O request; and
based on a determination that an adapter initiation command was utilized, increasing a current packet batch size applicable to a subsequent second I/O write request.

18. The data processing system of claim 17, wherein the program code, when executed, further causes the data processing system to perform:
based on a determination that an adapter initiation command was not utilized, retaining the current packet batch size.

19. The data processing system of claim 17, wherein the program code, when executed, further causes the data processing system to perform:
based on a determination that an adapter initiation command was not utilized, decreasing the current packet batch size.

20. The data processing system of claim 17, wherein increasing the current packet batch size includes increasing the current packet batch size an amount based on a then-current CPU cost for processing an adapter initiation command.

21. The data processing system of claim 17, wherein the determining includes executing an adapter abstraction layer firmware instruction to determine an adapter state of the I/O adapter.

22. The data processing system of claim 17, wherein:
the at least one data queue includes a plurality of data queues for buffering data payloads of I/O write requests; and
the determining includes determining the adapter state of the I/O adapter is busy based on the I/O adapter communicating I/O data with any of the plurality of data queues.

23. The data processing system of claim 17, wherein the operations further include iteratively optimizing the current packet batch size based on utilization of adapter initiation commands.

24. A computer-implemented method of optimizing input/output (I/O) packet batch sizes, the method comprising:
based on receiving a first I/O write request, issuing, by processing circuitry of a computer, a data available notification to an I/O adapter to initiate communication of a data payload of the first I/O write request from at least one data queue to an I/O adapter;
the processing circuitry determining whether an adapter initiation command was utilized to transition an adapter state of the I/O adapter from a quiescent state to a busy state to process the data payload of the first I/O write request;
based on a determination that an adapter initiation command was utilized, the processing circuitry increasing a current packet batch size applicable to a subsequent second I/O write request; and
the processing circuitry thereafter iteratively optimizing the current packet batch size on utilization of adapter initiation commands.

25. A computer program product, comprising:
a storage device; and
program code stored within the storage device and executable by processing circuitry of a data processing system to perform operations including:
based on receiving a first I/O write request, issuing a data available notification to an I/O adapter to initiate communication of a data payload of the first I/O write request from at least one data queue to an I/O adapter;
determining whether an adapter initiation command was utilized to transition an adapter state of the I/O adapter from a quiescent state to a busy state to process the data payload of the first I/O write request;
based on a determination that an adapter initiation command was utilized, increasing a current packet batch size applicable to a subsequent second I/O write request; and
thereafter iteratively optimizing the current packet batch size based on utilization of adapter initiation commands.
